(19) United States
(12) Patent Application Publication
(10) Pub. No.: US 2026/0257112 A1
(43) Pub. Date: Sep. 3, 2026

(54) COMPOSITE PICKLEBALL PADDLE

(71) Applicant: FUTURE COMP LLC, Gunnison, UT (US)

(72) Inventors: Joseph Stanish, Gunnison, UT (US); Nicholas Przybysz, Gunnison, UT (US)

(21) Appl. No.: 19/066,393

(22) Filed: Feb. 28, 2025

(51) Int. Cl. A63B 59/42; A63B 102/08; B32B 5/02; B32B 5/20; B32B 5/24; B32B 27/12; B32B 27/32

(52) U.S. Cl. CPC A63B 59/42; B32B 5/024; B32B 5/20; B32B 5/245; B32B 27/12; B32B 27/32; A63B 2102/08; A63B 2209/02; B32B 2250/40; B32B 2307/72

(57) ABSTRACT

A composite paddle includes an exterior frame having a first shell that includes a planar surface and handle portion on a first side of the paddle, the first side of the paddle further having a first lip disposed at a perimeter of the first shell and a second shell that includes a planar surface and handle portion on a second side of the paddle opposite the first side, the second side of the paddle further having a second lip disposed at a perimeter of the second shell. The composite paddle also includes a thermoplastic core material disposed between the first shell and the second shell and a reinforcement material disposed between the first shell and the second shell to provide stability and durability to the paddle.

### TECHNICAL FIELD

The present disclosure relates generally to sport equipment. More specifically, the present invention relates to pickleball paddles and the manufacture of paddles. The present invention further relates to a pickleball paddle having an improved impact response, construction, and manufacturing process.

### BACKGROUND

Pickleball is one of the fastest growing racquet sports. There is a continuing need to provide a pickleball paddle that improves a player's performance and/or confidence.

Panel materials of various types are known for use in articles such as sports equipment including paddles or bats intended for use in various ball sports, skis, surfboards, skateboards, wakeboards, and the like, all of which leverage high strength to weight properties. Sports paddles for use in playing paddleball, pickle ball, table tennis, padel tennis, smashball, and the like include a frame with a head portion. A face surface for the paddle can be made together with the frame or in a multiple step process to create the hitting surface area. The head portion surrounds and defines the hitting area. During play, the face surface is designed to contact and rebound a game piece such as a racquetball, tennis ball, or pickle ball.

Traditionally, the frames of sports paddles were made of wood. More recently, frames and paddles have been made from aluminum core, foam core, honeycomb structure core, and composite materials. In a more traditional wood or aluminum structure, the paddle is made entirely using these materials, which are cut to the desired finished shape. To complete the paddle, a handle is then built up using additional wood, aluminum, or other materials to increase the circumference of the handle. This process limits the weight to strength ratios as well as the ability to customize weight, balance, and the like. Traditional paddles are made of solid wood, injected plastics, or composite fiber. All of these paddle types can have tremendous disadvantages due to the construction methods and the limits due to the materials and technology.

An additional problem with the current design of paddles made from sandwich panels arises as a result of the edge treatments. Some manufacturers apply a u-channel or other type of molding to protect the edge and enclose the gap created by the core. This creates the problem of interference when striking the ball in this area of the paddle. Some manufacturers finish the edge with a composite material. This renders the edge of the paddle overly fragile, resulting in damage if the ground or a hard object is struck during play. All previous methods of finishing the edge of the paddle have created reliability issues, as the edge treatment tends to become loose and separate or fall off with age or stress.

Thus, it would be advantageous to have a paddle that did not require an edge treatment. This would require manufacturing the paddle such that the outer shell can be sealed but also to be strong enough to withstand hitting the ground or other objects without suffering damage. Accordingly, an alternative solution to forming a paddle that overcomes the shortcomings of the previous systems is desired.

### SUMMARY

Embodiments disclosed herein include systems, assemblies, and methods for forming a composite sports racket. Specifically, a composite paddle can include an exterior frame having a first shell including a planar surface and handle portion on a first side of the paddle, the first side of the paddle further having a first lip disposed at a perimeter of the first shell and a second shell including a planar surface and handle portion on a second side of the paddle opposite the first side, the second side of the paddle further having a second lip disposed at a perimeter of the second shell. In some examples, the composite paddle can include a thermoplastic core material disposed between the first shell and the second shell and a reinforcement material disposed between the first shell and the second shell to provide stability and durability to the paddle.

In some or all examples, the first lip can include a first contact surface and the second lip can include a second contact surface. In some examples, the first contact surface and the second contact surface are coupled together with a lap joint. In some examples, the lap joint can include a portion of the thermoplastic core material disposed between the first contact surface and the second contact surface and the portion of the thermoplastic core material is configured to bind the first shell and the second shell together. In some examples, the first shell and the second shell are fabricated from a polypropylene material.

In an example, the density of the thermoplastic core material can be between about 4 and about 53 pounds per cubic foot. In some examples, the thermoplastic core can include a uniform density. In other examples, the thermoplastic core can include a non-uniform density.

In some or all examples, the reinforcement material can include at least a first fiber sheet spanning the planar surface and a second fiber sheet contacting the first fiber sheet and extending into the handle portion. In some or all examples, the first shell and the second shell include at least two layers of thermoformed polymer.

In some or all examples, a method of forming a thermoplastic composite sports racket can include forming a first shell substructure having a thermoformed composite and forming a second shell substructure having a thermoformed composite. The method can also include placing the first shell substructure and the second shell substructure into an infrared radiation press. In an example, the first shell substructure and second shell substructure are coupled together at a lap joint around a perimeter of the first shell and the second shell, forming a hollow exterior structure. In some examples, the method further includes filling the hollow exterior structure with an expanding polymer material to form a composite structure and heating the composite structure under pressure. In some or all examples, the expanding polymer material is configured to flow against the lap joint and facilitate in applying pressure and ensuring a solid weld between the first shell substructure and the second shell substructure.

In some examples, the composite structure can be heated to between about 180° F. and about 630° F. In some examples, the composite structure can be heated at a pressure between about 30 psi and about 50 psi. In some examples, the expanding polymer material can include a bead structure. In other examples, the expanding polymer material can include a sheet structure. In some examples, the method can further include inserting a reinforcement fiber polymer between the first shell substructure and the second shell substructure.

In some examples, a thermoplastic composite sports racket can include a first substructure having a first lip disposed at a perimeter of the first substructure and a second substructure having a second lip disposed at a perimeter of the second substructure. In one or all examples, opposing ends of the first substructure and the second substructure can be bonded with one another to form a hollow structure. In some examples, the thermoplastic composite sports racket can include a core material disposed between the first substructure and the second substructure and a reinforced portion disposed within the core material.

In some examples, the reinforced portion within the core material can include a fiber polymer. In an example, the sports racket can include at least one of a pickleball paddle, a hockey stick, a ping-pong paddle, a padel racket, a baseball bat, a squash racket, a lacrosse stick, a boat paddle, a cricket bat, or a kayak paddle. In an example, the core material can include a thermoplastic resin and a foaming agent. In an example, the first substructure and the second substructure are bonded with one another in a lap joint welded together against the core material.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a front, plan view of an illustrative paddle for playing pickleball.

FIG. 2A is an illustration of an example frame system for a composite paddle.

FIG. 2B is an illustration of an example lap joint.

FIG. 3 is an illustration of a thermoplastic core material within a shell of a paddle and a mold block.

FIG. 4 is a block flow diagram of a method of forming a thermoplastic composite sports racket.

### DETAILED DESCRIPTION

Embodiments disclosed herein are related to assemblies, systems, and methods of manufacturing a sports paddle. While the present systems and methods are described in the context of forming a pickleball paddle, the teachings herein can be applied to form any hollow composite sports accessory including, but in no way limited to a pickleball paddle, a hockey stick, a ping-pong paddle, a padel racket, a baseball bat, a squash racket, a lacrosse stick, a boat paddle, a cricket bat, or a kayak paddle. The assemblies, systems, and methods of manufacturing a sports paddle include a system for manufacturing an exterior frame and a thermoplastic core such that the manufacturing is more efficient, and the response of the paddle is improved. For purposes of this disclosure, the term response means the manner in which a pickleball or another object leaves a paddle as it is struck. Subsumed within this definition is the degree of power or the degree of control that the player has over the ball using the paddle. In some examples, the paddle can be configured to, at least in part, provide stability and a long lifetime duration to the racket. In some examples, the manufacturing system and the reinforcements within the paddle can provide extra support to high volume surfaces or torque points of the paddle.

Specific embodiments of the disclosure are described with reference to the accompanying drawings. This disclosure may, however, be embodied in many different forms and should not be construed as limited to the embodiments set forth herein; rather, these embodiments are provided so that this disclosure will be thorough and complete, and conveys the scope of the disclosure to those skilled in the art. The terminology used in the detailed description of the embodiments illustrated in the accompanying drawings is not intended to be limiting of the disclosure.

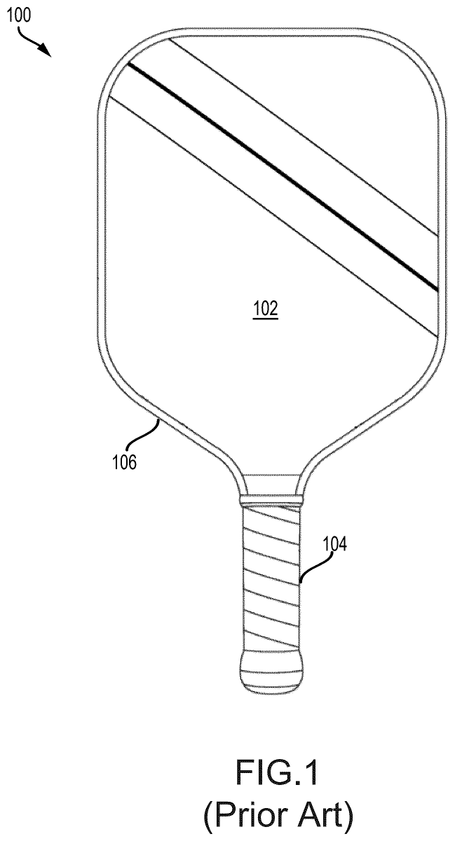

FIG. 1 is a front, plan view of an illustrative paddle 100 for playing pickleball. The paddle 100 includes a ball striking portion defining a head 102. The paddle 100 further includes a first planar face on a first side of the head, and a second planar face on a second side of the head 102 opposite the first side. A core material resides between the first planar surface and the second planar surface. The paddle further includes a handle portion 104. The pickleball paddle of FIG. 1 additionally includes a frame 106. The frame 106 includes a hoop portion that circumscribes the head 102, or that at least partially circumscribes the head 102. Unlike the present disclosure, the illustrated paddle shows the frame 106 extending from the striking surface and is arranged to provide stability to the paddle. Further, the frame 106 has a transition portion between the ball striking portion and the handle portion. The frame 106 includes at least one frame member extending into the handle portion 104 of the paddle 100. In some examples, the frame 106 can interfere with the ball striking portion or head 102 if the player does not hit the ball directly on the head 102.

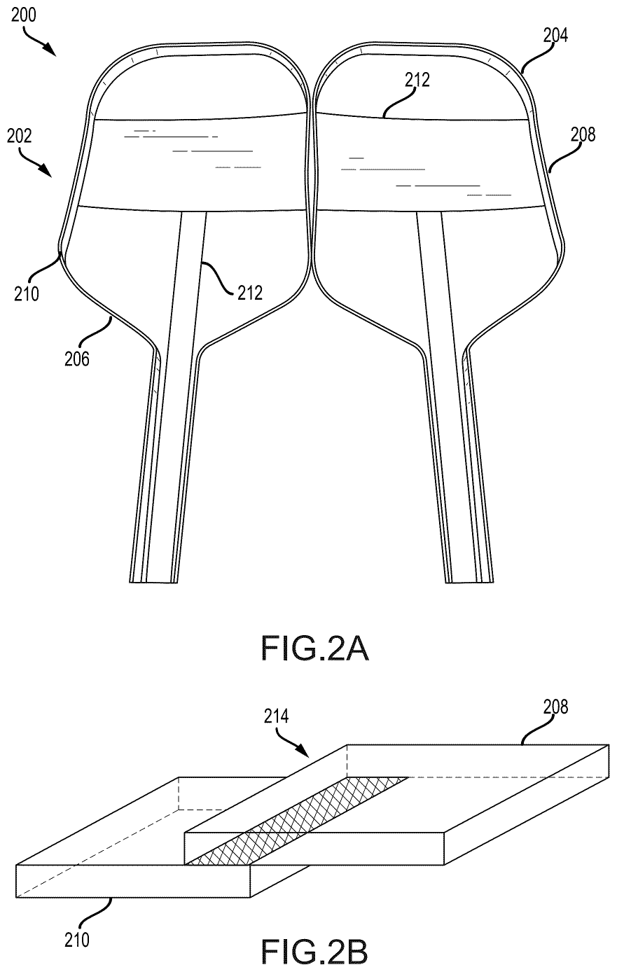

Referring to the figures of the present disclosure, FIG. 2A is an illustration of an example frame system for a composite paddle 200 or composite sports racket. In some examples the composite paddle 200 includes an exterior frame 202. The exterior frame 202 includes a first shell 204 or a first substructure having a planar surface and a handle portion on the first side of the paddle 200. In some examples, the planar surface of the paddle 200 includes the paddle head for ball striking. In some examples, the head of the paddle 200 can include a face or a skin covering the opposing surfaces of at least the planar surfaces of the exterior frame 202. The paddle 200 can include a second shell 206 or second substructure of the exterior frame 202. The second shell 206 can also include a planar surface and handle portion on a second side of the paddle opposite the first side.

In some examples, the face or skin of the paddle 200 can be smooth or textured. For example, the texture of the face of the paddle 200 can exhibit an average surface roughness (RZ) of less than or equal to 30 micrometers with no measurement greater than 33 micrometers. The texture of the face of the paddle 200 can exhibit an average surface roughness (RT) of greater than or equal to 35 micrometers and less than or equal to 40 micrometers, with no measurement above 44 micrometers.

In some examples, the first shell 204 and the second shell 206 can be fabricated from a polypropylene material. Polypropylene is a versatile thermoplastic that has many benefits. For example, Polypropylene is a tough plastic that can withstand daily use and various weather conditions. Polypropylene is highly resistant to moisture, oil, and other liquids. Polypropylene is heat-resistant and lightweight. Further, polypropylene has great impact strength and is amenable to coloring and formability, making it suitable for visually driven branding. Other suitable materials can be used as well. For example, the exterior frame 202 can be fabricated from aluminum, graphite or a stiff but lightweight polycarbonate material. In some examples, the first shell and the second shell can include at least two layers of thermoformed polymer.

In some examples, the first shell 204 and the second shell 206 can be formed from a reinforced thermoplastic material, also referred to herein as a fiber reinforced plastic (FRP). The reinforced thermoplastic material broadly includes reinforcement fibers that are disposed in a thermoplastic material. The thermoplastic material can be generally defined by a material that is softened through the application of heat and is conversely hardened when cooled. The thermoplastic material can be heated and cooled multiple, sequential times without substantial degradation of material properties. Certain resins, polymers, synthetics, nylons, and/or other materials can be used. The reinforcement fibers provide strength to the thermoplastic material. For example, the fibers can maintain the shape and physical state during the application of heat to the thermoplastic material. Sample fibers include carbon fibers, glass fibers, Kevlar fibers, basalt fibers, and/or other appropriate materials that can be adapted to provide strength to the thermoplastic material. In some examples, the fibers, individually or collectively, can be encased or partially encased in a coating. The coating can be a nano-coating that defines a barrier between the fibers and the thermoplastic material.

The reinforced thermoplastic material can be manufactured in a variety of manners to increase the strength of the material via the arrangement of the fibers. For example, in some cases, the fibers can be subjected to a spread technique that establishes the fibers in the thermoplastic material as a spread tow. In certain cases, this can allow a given cross-section of the reinforced thermoplastic material to have a width that is greater than a height. Additionally or alternatively, the spread technique or other manufacturing technique can arrange the fibers in an elongated fashion. For example, the fiber can be generally arranged substantially parallel to one another and elongated. Additionally or alternatively, the fibers can define a compact arrangement in the thermoplastic material. The compact arrangement can help organize the fibers in a manner to increase a density of the fibers in the reinforced thermoplastic material, by volume. For example, for a representative volume of the reinforced thermoplastic material, the fibers can define at least 40% of a volume of the material, at least 70% of a volume of the material, or other appropriate value based on the target strength and application. In some examples, the reinforced thermoplastic material can be unidirectional or woven. The fibers can include at least one layer. For example, the reinforced thermoplastic material can include a single layer of woven material or at least two layers of unidirectional material.

In some examples, the first side of the paddle 200 includes a first lip 208 disposed at a perimeter of the first shell 204. The second side of the paddle 200 can include a second lip 210 disposed at a perimeter of the second shell 206. In some examples, the first lip 208 and the second lip 210 include the first shell 204 and the second shell 206, respectively, having an angled surface at the edge of the shell. The angled surface can be at about 90° or greater, but when the first lip 208 and the second lip 210 are in contact the exterior frame 202 can be formed, leaving a hollow interior or core between the first shell 204 and the second shell 206. In some examples, the first lip 208 and the second lip 210 can have the same thickness. In some examples, the first lip 208 and the second lip 210 can have the same thickness as the planar surface of the exterior frame 202.

In some examples, the composite paddle 200 also includes a reinforcement material 212 disposed between the first shell 204 and the second shell 206 to provide stability and durability to the paddle 200. In an example, the reinforcement material 212 can be placed on an interior surface of the exterior frame 202. The reinforcement material 212 can be configured to strengthen surfaces of the exterior frame that are high impact. In some examples, the reinforcement material 212 can act to change the density of the paddle in strategic locations to provide localized reinforcement. In some examples, reinforcement material 212 can include at least a first fiber sheet spanning the planar surface and a second fiber sheet contacting the first fiber sheet and extending into the handle portion.

In some examples the reinforcement material 212 can include a fiber reinforced plastic or thermoplastic. Although light in weight, the strength to weight ratio of Fiber Reinforced Plastic (FRP) products surpasses that of equivalent steel products. FRP materials are composite materials that typically consist of strong fibers embedded in a resin matrix. The fibers can provide strength and stiffness to the composite and generally carry most of the stresses. The matrix acts to bond and protect the fibers and to provide for transfer of stress from fiber to fiber through shear stresses. The most common fibers are glass, carbon, and synthetic fibers. FRP composites have very high strength characteristics and are also lightweight. In some examples, the reinforcement material 212 can be added to the exterior frame 202 prior to filling the exterior frame 202 with a thermoplastic core material, discussed in greater detail below. In some examples, the reinforcement material 212 can be added and ultrasonically tac welded to an interior surface of the exterior frame 202 to ensure the reinforcement material 212 is in the proper location.

Referring to FIG. 2B, the first lip 208 of the first shell 204 and the second lip 210 of the second shell 206 can be bonded with one another to form a hollow structure that makes the exterior frame 202. In some examples, the first lip 208 and the second lip 210 can be configured to overlap. The first lip 208 and the second lip 210 can be sealed together. In some examples, the first lip 208 can include a first contact surface and the second lip 210 can include a second contact surface. The first contact surface and the second contact surface can be coupled together with a lap joint 214. Lap joint 214 can include an overlap joint or a joint in which the members overlap. In some examples, the lap joint 214 can be configured such that the first lip 208 and the second lip 210 overlap each other at a right angle. The strength of the joint depends on the combined thickness of the pieces being joined and how well the surfaces are aligned and fastened.

Generally speaking, the lap joint 214 includes a full lap joint. The full lap joint includes a joint wherein the first lip 208 overlaps the entire width of the second lip 210. However, other types of lap joints can be included. For example, the lap joint 214 can include a half lap joint, a cross lap joint, or a dovetail lap joint. In a half lap joint, both lips can include a subsurface having a thickness about halfway through their original thicknesses. This means each piece is cut or molded to half the depth, and when overlapped, the combined thickness is the same as the original thickness of the exterior frame 202. A cross lap joint involves cutting or molding both lips, so they intersect each other at right angles. Lastly, the dovetail lap joint combines the features of a traditional dovetail joint and a lap joint. The tail and pin shapes of a dovetail provide additional holding power. The full lap joint 214 can create a strong bond that can handle stress and impacts. Further, the lap joint can be relatively easy to create as explained in greater detail below.

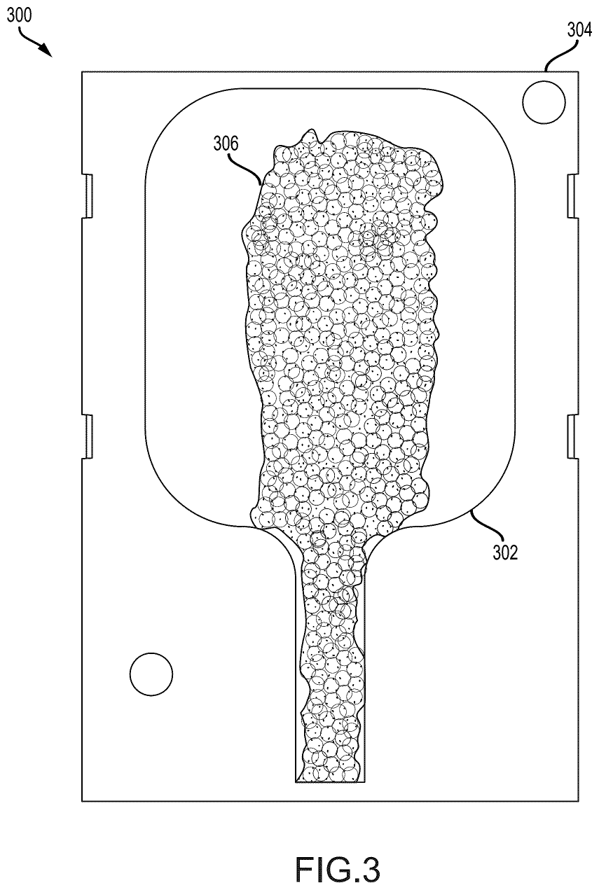

FIG. 3 is an illustration of a molding system 300 with a composite paddle exterior frame 302 within a mold block 304. Deposited within the exterior frame 302 is a thermoplastic core material 306. In a completed composite paddle, the thermoplastic core material 306 is disposed between a first shell substructure and a second shell substructure. In some examples, the core material 306 can include at least a thermoplastic resin and a foaming agent. In some examples, the core material 306 can be an expanding polymer material to form a composite structure. In an example, the expanding polymer material can include a bead structure. In other examples, the expanding polymer material can include a sheet structure. Expanded polymer materials are a type of foam that are made from polymers and can be molded into different shapes.

In some examples, the thermoplastic core material 306 can include a uniform density upon forming. In other examples, the thermoplastic core material 306 can be configured to include a non-uniform density. In other words, the thermoplastic core material 306 can be disposed within the exterior frame 302 such that upon expanding and forming the core of the composite paddle, the thermoplastic core material 306 has areas within the paddle having densities greater than other areas within the paddle.

In some examples, a core of the composite paddle frame 302 can include other materials or other systems within the core to further reinforce the paddle frame 302. For example, a graphite structure can be added to a high impact area of the paddle to improve wear. In some examples, a tungsten or aluminum structure could be added to an interior of the composite paddle frame 302 for improved strength. In some examples, a core material having a different material (e.g., crushed foam) could be added to create variable densities within the paddle. In some examples open cell foam can be used in conjunction with expanding foam to create duel or multiple density cores within the paddle.

In some examples, the density of the thermoplastic core material 306 can be between about 4 and about 53 pounds per cubic foot. In some examples, the density of the thermoplastic core material 306 can be greater than about 4 pounds per cubic foot, greater than about 5 pounds per cubic foot, greater than about 6 pounds per cubic foot, greater than about 10 pounds per cubic foot, greater than about 20 pounds per cubic foot, greater than about 30 pounds per cubic foot, greater than about 40 pounds per cubic foot, or greater than about 50 pounds per cubic foot. In some examples, the density of the thermoplastic core material 306 can be less than 53 pounds per cubic foot, less than 40 pounds per cubic foot, less than 30 pounds per cubic foot, less than 20 pounds per cubic foot, less than 10 pounds per cubic foot, less than 8 pounds per cubic foot, or less than about 5 pounds per cubic foot. In some examples, the density of the thermoplastic core material 306 can be in a range between about 4 pounds per cubic foot and about 5 pounds per cubic foot, between about 5 pounds per cubic foot and about 6 pounds per cubic foot, between about 6 pounds per cubic foot and about 7 pounds per cubic foot, between about 7 pounds per cubic foot and about 10 pounds per cubic foot, between about 10 pounds per cubic foot and about 20 pounds per cubic foot, between about 20 pounds per cubic foot and about 30 pounds per cubic foot, between about 30 pounds per cubic foot and about 40 pounds per cubic foot, between about 40 pounds per cubic foot and about 50 pounds per cubic foot, or between about 50 and about 53 pounds per cubic foot.

In some examples, the lap joint of the first lip and the second lip of the composite paddle can include a portion of the thermoplastic core material 306 disposed against the first lip and second lip to exert a force on the material as it is thermally bonded. In some examples, the portion of the thermoplastic core material 306 is configured to impart a force on the interface portion of the first shell and the second shell as they are bonded together. In other words, referring back to FIG. 2B, the lap joint 214 can be formed by the thermoplastic core material 306 being disposed against the overlap portion of the first lip 208 and the second lip 210 as thermal energy is applied to thermally bond the interface, forming the lap joint 214. In this manner, the thermally bonded lap joint 214 can be substantially invisible to the naked eye in the final product, and as such, define a seamless interface or transition between the first lip 208 and the second lip 210. In some other examples, the thermoplastic core material 306 can act as a bonding agent for the lap joint, flowing between the first substructure and the second substructure with the application of thermal energy, bonding the two substructures together at the lap joint. In this way, the paddle 200 can be formed with the thermoplastic core material 306 acting to facilitate the weld for the lap joint by controlling the molding conditions for the molding system 300.

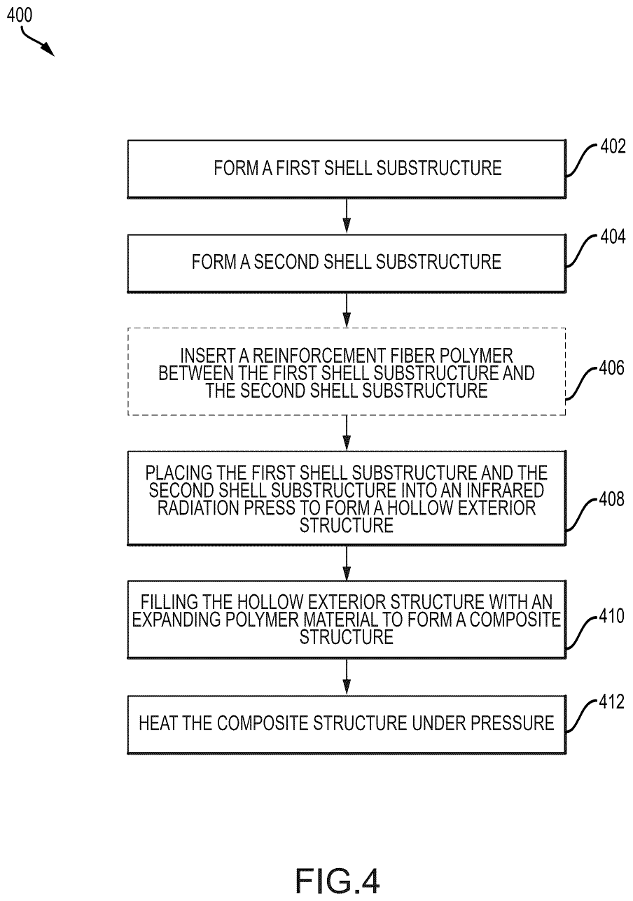

FIG. 4 is a block flow diagram for a method 400 to form a thermoplastic composite sports racket. The method 400 for forming a thermoplastic composite sports racket can utilize use any of the composite racket components and/or mold systems or assemblies disclosed herein. The method 400 may include block 402, which forming a first shell substructure comprising a thermoformed composite. The thermoformed composite can include a fibrous shell, a graphite structure, or polypropylene. However, other suitable materials can be used for the shell of the sports racket, as required for the sport and/or use. Block 402 may be followed by block 404, which includes forming a second shell substructure comprising a thermoformed composite. In some examples, the second shell and the first shell can include a second lip and a first lip respectfully which are configured to fit together. Thus, by completing blocks 402 and 404, an exterior frame of a sports racket, such as a pickleball paddle, can be formed, assembled, and prepared for operation.

Blocks 402 and 404 of the method 400 are shown for illustrative purposes. For example, all acts or blocks illustrated of the method 400 may be performed in different orders, split into multiple acts, modified, supplemented, or combined. In an example, one or more of the acts of the method 400 may be omitted from the method 400. Any of the acts of the method 400 can include using any of the assemblies, structures, materials, or, processes disclosed herein.

The method 400 can also optionally include the block 406, which includes inserting a reinforcement fiber polymer between the first shell substructure and the second shell substructure. The reinforcement fiber polymer can be placed in predetermined areas or high stress areas of the paddle to extend the life of the part or to create different effects for the sports racket. For example, the sports racket is not limited to pickleball paddles. The method can be used to construct a hockey stick, a ping-pong paddle, a padel racket, a baseball bat, a squash racket, a lacrosse stick, a boat paddle, or a kayak paddle. In some examples, the paddle or racket can further include other materials such as graphite, tungsten, or aluminum to reinforce or create alternate effects or densities within the racket.

The method also includes block 408, which is placing the first shell substructure and the second shell substructure into an infrared (IR) radiation press. The IR radiation press is configured to create conditions to form the paddle. The first shell substructure and second shell substructure are coupled together at a lap joint around a perimeter of the first shell and the second shell, forming a hollow exterior structure. Within the IR radiation press, in some examples, the method also includes block 410, which includes filling the hollow exterior structure with an expanding polymer material to form a composite structure. In some examples, the expanding polymer material can include a bead structure. In other examples, the expanding polymer material can include a sheet structure. In yet other examples, the expanding polymer material can include both a bead and a sheet structure.

The method 400 further includes block 412, which includes heating the composite structure under pressure. In some examples, the composite structure is heated to between about 180° F. and about 630° F. The thermoplastic core and/or expanding polymer material can be configured to expand at about 190° F. and build pressure at about 290° F. In some examples, the composite structure is heated to greater than about 180° F., greater than about 200° F., greater than about 220° F., greater than about 240° F., greater than about 260° F., greater than about 280° F., greater than about 300° F., greater than about 350° F., greater than about 375° F., greater than about 400° F., greater than about 425° F., greater than about 450° F., greater than about 475° F., greater than about 500° F., greater than about 525° F., greater than about 550° F., greater than about 575° F., greater than about 600° F., or greater than about 625° F. In some examples, the composite structure can be heated to between about 190° F. and about 210° F., between about 210° F. and about 230° F., between about 230° F. and about 250° F., between about 250° F. and about 300° F., between about 300° F. and about 350° F., between about 350° F. and about 400° F., between about 400° F. and about 450° F., between about 450° F. and about 500° F., between about 500° F. and about 550° F., between about 550° F. and about 600° F., or between about 600° F. and about 630° F.

In some examples, the composite structure is heated at a pressure between about 30 pounds per square inch (psi) and about 50 psi. The composite structure can be heated at a pressure greater than 30 psi, greater than 35 psi, greater than 40 psi, or greater than 45 psi. In some examples, the composite structure can be heated at a pressure between about 30 psi and about 35 psi, between about 35 psi and about 40 psi, between about 40 psi and about 45 psi, or between about 45 psi and about 50 psi.

In some examples, the composite structure can be heated at a pressure and temperature where the expanding polymer material is configured to flow against the lap joint exert a force aiding to weld the first shell substructure and the second shell substructure together. Any excess material that may flow out of the lap joint can be cut or otherwise processed to create a smooth joint.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or +2% of the term indicating quantity. Further, the terms “less than,” “or less,” “greater than,” “more than,” or “or more” include, as an endpoint, the value that is modified by the terms “less than,” “or less,” “greater than,” “more than,” or “or more.” In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

As used herein, conjunctive terms (e.g., “and”) and disjunctive terms (e.g., “or”) should be read as being interchangeable (e.g., “and/or”) whenever possible. Furthermore, in claims reciting a selection from a list of elements following the phrase “at least one of,” usage of “and” (e.g., “at least one of A and B”) requires at least one of each of the listed elements (i.e., at least one of A and at least one of B), and usage of “or” (e.g., “at least one of A or B”) requires at least one of any individual listed element (i.e., at least one of A or at least one of B). It is noted that, when described or recited herein, the use of the articles such as “a” or “an” is not considered to be limiting to only one, but instead is intended to mean one or more unless otherwise specifically noted herein.

What is claimed is:

1. A composite paddle, comprising:
an exterior frame comprising:
a first shell comprising a planar surface and handle portion on a first side of the paddle, the first side of the paddle further comprising a first lip disposed at a perimeter of the first shell; and
a second shell comprising a planar surface and handle portion on a second side of the paddle opposite the first side, the second side of the paddle further comprising a second lip disposed at a perimeter of the second shell;
a thermoplastic core material disposed between the first shell and the second shell; and
a reinforcement material disposed between the first shell and the second shell to provide stability and durability to the paddle.

2. The composite paddle of claim 1, wherein the first lip comprises a first contact surface and the second lip comprises a second contact surface, wherein the first contact surface and the second contact surface are coupled together with a lap joint.

3. The composite paddle of claim 2, wherein the lap joint comprises a portion of the thermoplastic core material disposed adjacent to the first contact surface and the second contact surface.

4. The composite paddle of claim 1, wherein the first shell and the second shell each comprise a polypropylene.

5. The composite paddle of claim 1, wherein a density of the thermoplastic core material is between about 4 and about 53 pounds per cubic foot.

6. The composite paddle of claim 1, wherein the thermoplastic core comprises a uniform density.

7. The composite paddle of claim 1, wherein the thermoplastic core comprises a non-uniform density.

8. The composite paddle of claim 1, wherein the reinforcement material comprises at least a first fiber sheet spanning the planar surface and a second fiber sheet contacting the first fiber sheet and extending into the handle portion.

9. The composite paddle of claim 1, wherein the first shell and the second shell each comprises at least two layers of thermoformed polymer.

10. A method of forming a thermoplastic composite sports racket, the method comprising:
forming a first shell substructure comprising a thermoformed composite;
forming a second shell substructure comprising a thermoformed composite;
placing the first shell substructure and the second shell substructure into an infrared radiation press, wherein the first shell substructure and second shell substructure are coupled together at a lap joint around a perimeter of the first shell and the second shell, forming a hollow exterior structure;
filling the hollow exterior structure with an expanding polymer material to form a composite structure;
heating the composite structure under pressure, wherein the expanding polymer material is configured to flow against the lap joint and weld the first shell substructure and the second shell substructure together.

11. The method of claim 10, wherein the composite structure is heated to between about 180° F. and about 630° F.

12. The method of claim 10, wherein the composite structure is heated at a pressure between about 30 psi and about 50 psi.

13. The method of claim 10, wherein the expanding polymer material comprises a bead structure.

14. The method of claim 10, wherein the expanding polymer material comprises a sheet structure.

15. The method of claim 10, further comprising inserting a reinforcement fiber polymer between the first shell substructure and the second shell substructure.

16. A thermoplastic composite sports racket, comprising:
a first substructure comprising a first lip disposed at a perimeter of the first substructure;
a second substructure comprising a second lip disposed at a perimeter of the second substructure, wherein opposing ends of the first substructure and the second substructure are bonded with one another to form a hollow structure;
a core material disposed between the first substructure and the second substructure; and
a reinforced portion disposed within the core material.

17. The thermoplastic composite sports racket of claim 16, wherein the reinforced portion within the core material comprises a fiber polymer.

18. The thermoplastic composite sports racket of claim 16, wherein the thermoplastic composite sports racket comprises at least one of a pickleball paddle, a hocky stick, a ping-pong paddle, a padel racket, a baseball bat, a squash racket, a lacrosse stick, a boat paddle, or a kayak paddle.

19. The thermoplastic composite sports racket of claim 16, wherein the core material comprises a thermoplastic resin and a foaming agent.

20. The thermoplastic composite sports racket of claim 19, wherein the first substructure is bonded to the second substructure in a lap joint welded together with the core material.
